(19) United States
(12) Patent Application Publication
(10) Pub. No.: US 2025/0265446 A1
(43) Pub. Date: Aug. 21, 2025

(54) INCIDENT RESPONSE USING LARGE LANGUAGE MODELS

(71) Applicant: International Business Machines Corporation, Armonl, NY (US)

(72) Inventors: Jeffery Crume, Raleigh, NC (US); Aankur Bhatia, Bethpage, NY (US); Walid Rjaibi, Markham, CA (US); Youngja Park, Princeton, NY (US)

(21) Appl. No.: 18/583,712

(22) Filed: Feb. 21, 2024

(51) Int. Cl. G06N 3/045; G06N 3/08

(52) U.S. Cl. CPC G06N 3/045; G06N 3/08

(57) ABSTRACT

A computer-implemented method (CIM), according to one embodiment, includes, tuning a plurality of Large Language Models (LLMs) to debate one another to determine solutions for incidents, and causing data associated with a first incident to be input into the LLMs. The method further includes incorporating solutions output by the LLMs into a recommendation for resolving the first incident. The recommendation weighs trade-offs of different possible resolutions for solving the first incident. The method further includes outputting the recommendation to a user interface of a user device. A computer program product (CPP), according to another embodiment, includes a set of one or more computer-readable storage media, and program instructions, collectively stored in the set of one or more storage media, for causing a processor set to perform the foregoing method.

### BACKGROUND

The present invention relates to machine learning, and more specifically, this invention relates to Large Language Models (LLMs).

A cybersecurity incident is an event during which an authorized party, e.g., an unauthorized user device, is able to access and potentially acquire private information. This private information may be stored on security devices, e.g., such as in memory of a firewall and/or password protected server, that are accessed by the unauthorized party.

### SUMMARY

A computer-implemented method (CIM), according to one embodiment, includes, tuning a plurality of Large Language Models (LLMs) to debate one another to determine solutions for incidents, and causing data associated with a first incident to be input into the LLMs. The method further includes incorporating solutions output by the LLMs into a recommendation for resolving the first incident. The recommendation weighs trade-offs of different possible resolutions for solving the first incident. The method further includes outputting the recommendation to a user interface of a user device.

A computer program product (CPP), according to another embodiment, includes a set of one or more computer-readable storage media, and program instructions, collectively stored in the set of one or more storage media, for causing a processor set to perform the foregoing method.

A computer system (CS), according to another embodiment, includes a processor set, a set of one or more computer-readable storage media, and program instructions, collectively stored in the set of one or more storage media, for causing the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is an environment architecture, in accordance with one embodiment of the present invention.

FIG. 4 is a question thread, in accordance with one embodiment of the present invention.

FIG. 5 is an environment architecture, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods, and computer program products for causing large language models to debate one another to determine solutions for incidents.

In one general embodiment, a CIM includes, tuning a plurality of LLMs to debate one another to determine solutions for incidents, and causing data associated with a first incident to be input into the LLMs. The method further includes incorporating solutions output by the LLMs into a recommendation for resolving the first incident. The recommendation weighs trade-offs of different possible resolutions for solving the first incident. The method further includes outputting the recommendation to a user interface of a user device.

In another general embodiment, a CPP includes a set of one or more computer-readable storage media, and program instructions, collectively stored in the set of one or more storage media, for causing a processor set to perform the foregoing method.

In another general embodiment, a CS includes a processor set, a set of one or more computer-readable storage media, and program instructions, collectively stored in the set of one or more storage media, for causing the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as LLM fine-tuning code of block 150 for causing large language models to debate one another to determine solutions for incidents. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

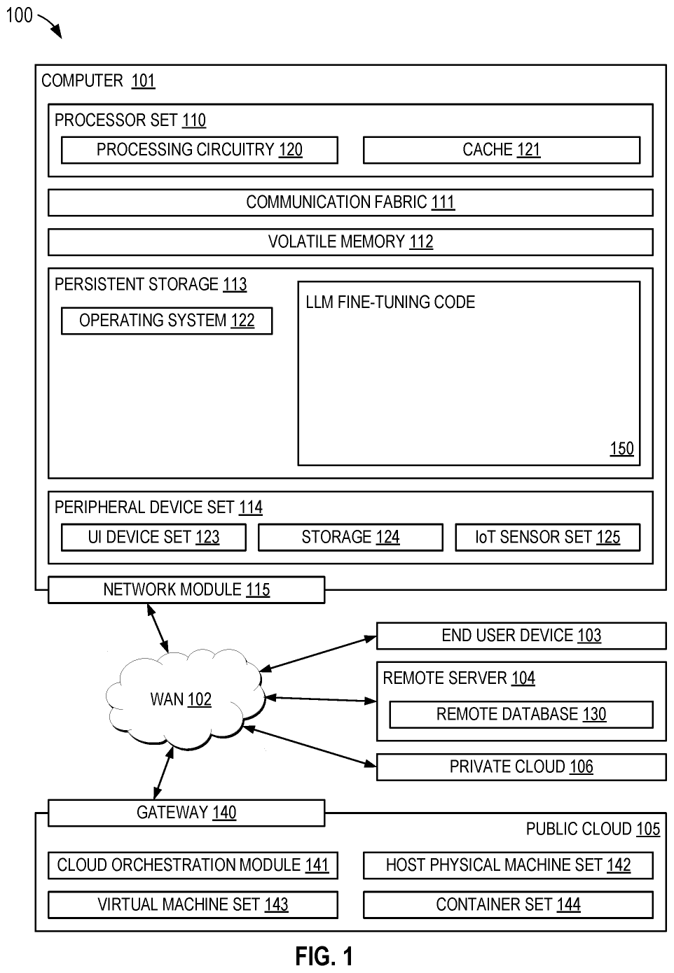

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, a cybersecurity incident is an event during which an authorized party, e.g., an unauthorized user device, is able to access and potentially acquire private information. This private information may be stored on security devices, e.g., such as in memory of a firewall and/or password protected server, that are accessed by the unauthorized party.

Once a cybersecurity incident has occurred, time is of the essence. Limiting further damage is a priority and acting with speed is critical. However, some actions which have the potential for stopping the breach may also end up crippling normal operations of an organization that is breached, if not handled carefully. Multiple responses are possible and, today, cybersecurity analysts are used to weigh the pros and cons of various solutions to the cybersecurity events. However, these cybersecurity analysts may not think of, and in some cases possibly forget to consider, techniques for implementing the best course of action. Under pressure, the possibility of mistakes is high, and it is possible that the situation could be made worse, creating unintended consequences. Furthermore, otherwise relying on humans to develop a response to a cybersecurity incident is flawed in that humans are not able to develop and adapt solutions at a speed that even remotely comparable to the speeds that unauthorized user devices are able to access, acquire and exploit private information. Accordingly, there is a longstanding need within the technical field of networks and data storage systems for techniques for responding to potential and actual incidents of unauthorized access of private information.

In sharp contrast to the deficiencies described above, the techniques of embodiments and approaches described herein leverage the power of LLMs to analyze a cybersecurity incident, consider potential responses, weigh the alternatives, and recommend a course of action based upon a trade-off analysis.

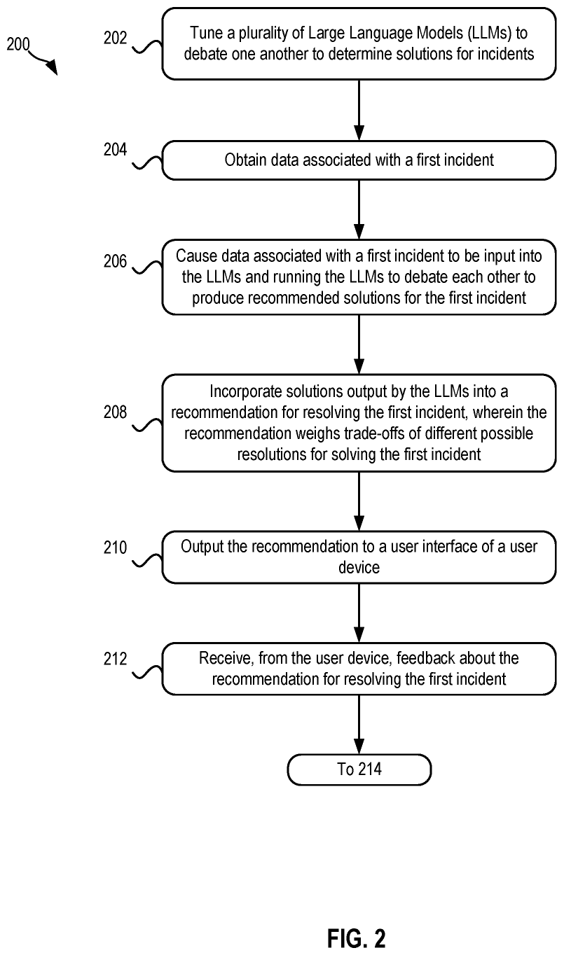

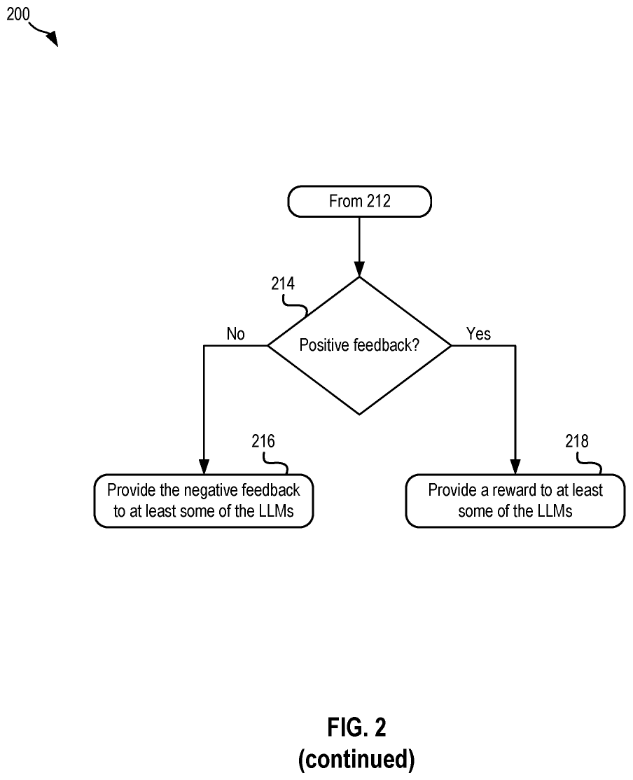

Now referring to FIG. 2, a flowchart of a method 200 is shown according to one embodiment. The method 200 may be performed in accordance with the present invention in any of the environments depicted in FIGS. 1-5, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes tuning a plurality of LLMs to debate one another to determine solutions for incidents. For context, in some preferred approaches, the LLMs may be tuned to include LLMs that are, as a result of the tuning process, thereby preconfigured for evaluating different aspects of incidents and recommending potential solutions based on the evaluation. In some approaches, in order to preconfigure the LLMs in such a way, different training data may be used for tuning the different LLMs to debate one another. For example, in some approaches, the training data may include security data including past incident data, vulnerability and mitigation data, and cyberthreat intelligence data, and/or any other type of data that would become apparent to one of ordinary skill in the art after reading the descriptions herein.

The model tuning may, in some approaches, additionally and/or alternatively utilizes prompt-tuning techniques of a type that would become apparent to one of ordinary skill in the art after reading the descriptions herein. In other words, in some approaches, the model tuning may include fine-tuning and/or prompt tuning.

In some preferred approaches, a first of the LLMs may be configured to search one or more web search engines for determining one or more suggestions for resolving an incident. A second of the LLMs may, in some approaches, be a foundation model for actionable prompts. In some other approaches, a third of the LLMs may be a general-purpose programming language model for executing and evaluating code. A fourth of the LLMs may be a foundation model for mitigation recommendations in that the foundation model may be preconfigured to associate and thereby pair different incidents with predetermined solutions. A fifth of the LLMs may be a foundation model for reasoning.

At least some of the LLMs, and in some approaches each of the LLMs of the plurality of LLMs, may have different model architectures. In some other approaches, all of the LLMs can have the same architecture. According to some illustrative approaches, these model architectures may include encoder models, encoder-decoder models, decoder-only models, etc.

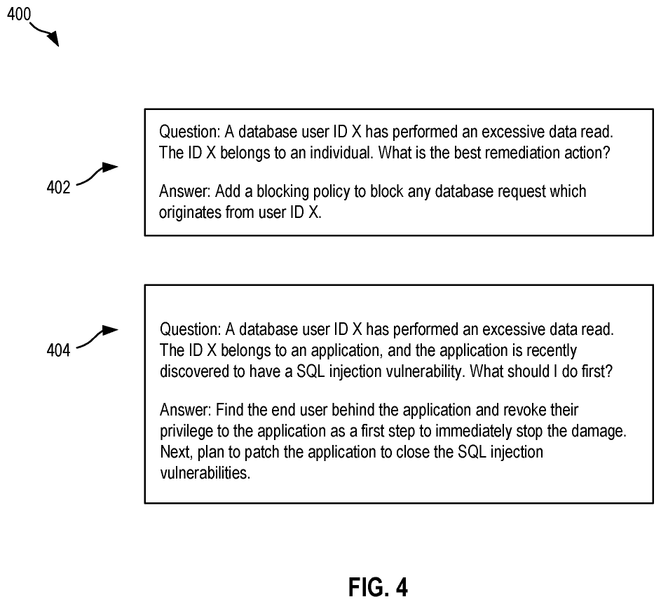

Once the LLMs are tuned, e.g., trained, and/or during tuning of the LLMs, incidents may occur that the LLMs are configured to determine a solution for. For context, incidents may be defined as any type of issue that a question may be based off of, where the question requests solution(s), e.g., answer(s), regarding how to resolve the incident. In preferred approaches, such incidents may include security incidents. Operation 204 includes obtaining data associated with a first incident. In some approaches, at least some of the data associated with the first incident is received in a question received from a user device. Accordingly, the question may be parsed using a natural language processing technique that would become apparent to one of ordinary skill after reading the descriptions herein, e.g., parsed using these techniques to identify predetermined keywords and/or conditions. For example, the question may, in some approaches, specify conditions of a device environment and/or device that were used to identify the incident, e.g., conditions monitored for by a security device associated with an analyst. In some approaches, these conditions may include, e.g., an unauthorized access of data, a loss of performance of a computer device, a data read of more than a predetermined size (also referred to herein as an “excessive data read”), etc. Device information and/or metadata that details identification of these conditions may be included in the data associated with the first incident. Examples of questions that detail an incident are described in greater detail elsewhere herein, e.g., see FIG. 4.

Operation 206 includes causing data associated with a first incident to be input into the LLMs and running the LLMs to debate each other to produce recommended solutions for the first incident, e.g., subsequent to at least some tuning being performed on the LLMs. More specifically, the LLMs are, in some preferred approaches, instructed to debate one another to determine at least one, and preferably a plurality of potential resolutions for solving the incident. These resolutions may include, e.g., device instructions for mitigating and/or recovering from the incident, instructions for determining a potential scope of the incident, devices to power down in order to prevent harm occurring from the incident, authorities and/or administrators to notify about the incident, etc. In the process of debating one another, at least some of the potential resolutions that are generated by one or more of the LLMs may be disposed of and thereby not output by the LLMs. In some approaches, these potential resolutions are disposed of as a result of at least a predetermined number of the LLMs disagreeing with the potential resolution and/or supporting other potential resolution(s) that conflict with the potential resolutions that are ultimately disposed of. Furthermore, one or more potential resolutions may be included in an output of the LLMs in response to at least a predetermined number of LLMs agreeing with the potential resolution.

In some approaches, one or more of the LLMs may be assigned different weights. For context, each weight establishes an extent of influence that an associated LLM has while debating the other LLMs to determine solutions for incidents. For example, a first LLM having a relatively low weight that debates for a first potential resolution may be overruled by a second LLM having a relatively higher weight that debates for a second potential resolution. Accordingly, method 200 optionally includes assigning weight to the LLMs. In some approaches, each of the LLMs are initially assigned the same default weight. Over time, the weight may be updated, as will be described elsewhere herein, e.g., see operation 218.

Operation 208 includes incorporating solutions output by the tuned LLMs into a recommendation for resolving the first incident. For context, incorporating the solutions into the recommendation may, in some approaches, merely include appending the solutions as entries in the recommendation. However, in some approaches, incorporating the solutions into the recommendation may additionally and/or alternatively include adding details to the recommendation that distinguish the different possible resolutions from one another. For example, in some preferred approaches in which the recommendation includes a plurality of different possible resolutions, the recommendation weighs trade-offs of different possible resolutions for solving the first incident, where the trade-offs are based on the solutions output by the trained LLMs. These trade-offs may include sorting the different possible resolutions in a tiered priority list, e.g., where possible resolutions debated for by LLMs having relatively greater weights are sorted to relatively higher tiers in the list and possible resolutions debated for by LLMs having relatively lower weights are sorted to relatively lower tiers in the list.

In some approaches, incorporating the solutions into the recommendation may additionally and/or alternatively include refining the possible resolutions that are to be included in the recommendation. For example, in some approaches, a preferred one of the resolutions is determined and then highlighted within the recommendation. This determination may be performed by a program that is configured to compare the possible resolutions with a predetermined ruleset. For example, the predetermined ruleset may specify types of possible resolutions to exclude from recommendations. In some other approaches, this refinement may be performed by a predetermined one of the LLMs, e.g., the LLM with the relatively highest current weight determines the preferred possible resolution, a trained artificial intelligence (AI) model (or subject matter expert) provides current priority rules for one of the LLMs that analyzes the data associated with the first incident last, etc.

The recommendation is output to a user interface of a user device, e.g., see operation 210. In some approaches the user device is the user device from which the questions is received.

Feedback about the recommendation for resolving the first incident may be received from the user device, e.g., see operation 212. This feedback may be useful for determining how to further tune the LLMs in order to thereby achieve relatively more accurate resolutions for other incidents. Accordingly, the feedback may be analyzed to determine whether the feedback is positive feedback or negative feedback, e.g., see decision 214. This analysis may, in some approaches, include performing NLP to potentially identify keywords that are predetermined to be associated with positive feedback, e.g., great, accurate, on-point, applicable, etc., and/or keywords/phrases that are predetermined to be associated with negative feedback, e.g., bad, inaccurate, not on-point, not applicable, useless, etc.

In response to a determination that the feedback is positive feedback, e.g., as illustrated by the “Yes” logical path of decision 214, method 200 optionally includes providing a reward to at least some of the LLMs, e.g., see operation 218. In some approaches, the reward includes increasing the weights assigned to the determined LLMs a predetermined amount. Other techniques for rewarding one or more LLMs of a type that would become apparent to one of ordinary skill in the art after reading the descriptions herein may be used.

In some other approaches, in response to a determination that the feedback is negative feedback, e.g., as illustrated by the “No” logical path of decision 214, method 200 optionally includes providing the negative feedback to at least some of the LLMs, e.g., see operation 216. Providing the negative feedback to at least some of the LLMs may, in some approaches, include determining the LLMs that debated for including the solutions output by the tuned LLMs, and decreasing the weights assigned to the determined LLMs a predetermined amount.

The techniques described herein leverage an AI-based debate capability in order to consider the pros and cons of various cybersecurity attack countermeasures and recommend the best course of action. These determinations are not able to be performed in the human mind because the human mind is unable to perform such deliberations without incorporating a subliminal bias and/or errors, and furthermore is unable to fully consider a broader set of conditions that must be taken into account before remediation can begin.

A use case example, in which the techniques described in method 200 may be used to resolve a security incident includes a database anomaly capability having detected that database user ID “X” has performed an excessive data read on a database, e.g., greater than a predetermined amount of data is read. Such a data read may be indicative of a data leakage incident, and therefore the techniques described herein may be applied in order to enable an appropriate action to be taken to protect the database and limit further damage. Some potential actions for potentially resolving the incident include, e.g., a first action in which user ID X is quarantined in a user authentication system set up for the database (e.g., Active Directory), a second action that includes user ID X's privilege to connect to the database being revoked (e.g., in a second database, a SQL statement: “REVOKE CONNECT ON DATABASE FROM USER X” may be run), and a third action that includes adding a blocking policy in the database anomaly capability to block any database request which originates from user ID X. Any of these actions may be appropriate if user ID X is an actual individual. For example, the third action would be relatively most effective and fastest to protect the database and limit the damage, while the first and second options are not as fast because a notification must be generated and sent to the appropriate administrator to take the action. However, these actions fail to consider whether user ID X is an application ID. This is problematic because any of these actions have the potential for causing severe consequences as they will impact all users of the application and ultimately disrupt business operations. Additionally, the incident may have nothing to do with user ID X itself. For example, a malicious user (or hacker) may have found an SQL injection vulnerability in the application and fooled such application to execute SQL under user ID X to retrieve a large data set. In this case, it would be less disruptive to limit the malicious user's access to the application as a first step, and then, plan to patch the application.

The techniques described herein automate and streamline the process of determining a resolution for the incident. In this process, the LLMs are able to look at database connection details to identify whether user ID X is an actual individual or an application ID that is used by an application to serve the needs of the application's actual end users as in the three-tier application model described above. In response to a determination that user ID X is an individual, the techniques described herein recommend the third action. In contrast, in response to a determination that user ID X is an application, the techniques described herein asks for more context (such as whether the database anomaly capability has indicated this is an SQL injection as well as the actual end user behind the application). Armed with this information, the techniques described herein may be used to generate an alert for an application administrator device to revoke the end user's privilege to use the application as a first action, and then plan to patch the application to close the SQL injection vulnerability, thereby solving the incident.

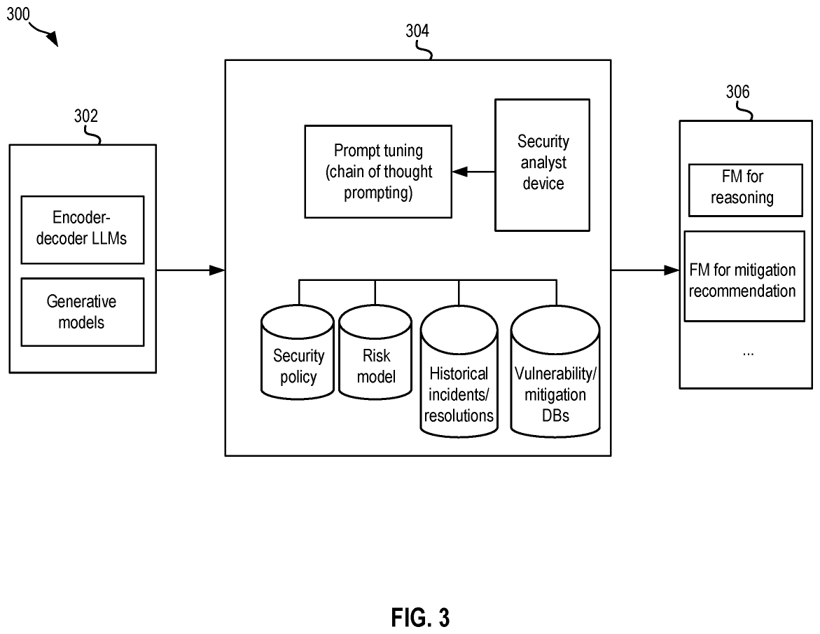

FIG. 3 depicts an environment architecture 300, in accordance with one embodiment. As an option, the present environment architecture 300 may be implemented in conjunction with features from any other embodiment listed herein, such as those described with reference to the other FIGS. Of course, however, such environment architecture 300 and others presented herein may be used in various applications and/or in permutations which may or may not be specifically described in the illustrative embodiments listed herein. Further, the environment architecture 300 presented herein may be used in any desired environment.

The environment architecture 300 includes infrastructure for fine tuning LLMs. For example, the environment architecture 300 includes pre-trained AI models 302 that are input into a mitigation recommendation tuning engine 304, e.g., see encoder-decoder LLMs and generative models input into the mitigation recommendation tuning engine 304. In the mitigation recommendation tuning engine 304, the models are tuned with prompt tuning, in some approaches, which may be fed by security analysts. The prompt tuning incorporates a plurality of training data, e.g., see security policy (which may include security data including past incident data), risk model (which may include vulnerability and mitigation data), historical incidents/resolutions, and vulnerability/mitigation DBs (which may include cyberthreat intelligence). In one approach, this training includes training one or more of the LLMs by providing training examples using past incidents, final resolutions taken, the reasons why the final resolutions were taken, etc.

An output of the fine tuning engine 304 includes tuned LLMs 306, which may include an LLM for reasoning, an LLM for mitigation recommendations, etc. In other words, the LLMs may have different model architectures such as encoder models, encoder-decoder, or decoder-only models, in some approaches. To choose a relatively most effective action against a security incident, the tuned LLMs consider many different factors and assess the benefits and risks for each option. These LLMs perform reasoning and compare or rank different options. One way of training LLM(s) to perform this is a chain of thought prompting techniques. Another way is having multiple LLMs debate each other and produce an optimal solution together.

FIG. 4 depicts a question thread 400, in accordance with one embodiment. As an option, the present question thread 400 may be implemented in conjunction with features from any other embodiment listed herein, such as those described with reference to the other FIGS. Of course, however, such question thread 400 and others presented herein may be used in various applications and/or in permutations which may or may not be specifically described in the illustrative embodiments listed herein. Further, the question thread 400 presented herein may be used in any desired environment.

The question thread 400 includes a first question session 402 and a second question session 404 that include questions and answers. The first question session may be exchanged between a user device that generates the question and an infrastructure with LLMs that have not been tuned using the techniques described herein, e.g., see method 200. The question of the first question session 402 is associated with a first incident that is based on a database user ID X that has performed an excessive data read. The answer of the first question session fails to consider whether user ID X is an application ID. This is problematic because the action of the answer, e.g., blocking policy implementation, has the potential for causing severe consequences that impact all users of the associated application and ultimately disrupt business operations.

In sharp contrast, the second question session may be exchanged between a user device that generates the question and an infrastructure with LLMs that have been tuned using the techniques described herein, e.g., see method 200. The answer to the first question uses a plurality of tuned LLMs that debate one another to consider factors ignored in the first question session to determine an action that is based on the factors. These factors may include, e.g., information on the security incident, a company's security policies, circumstantial contexts, etc.

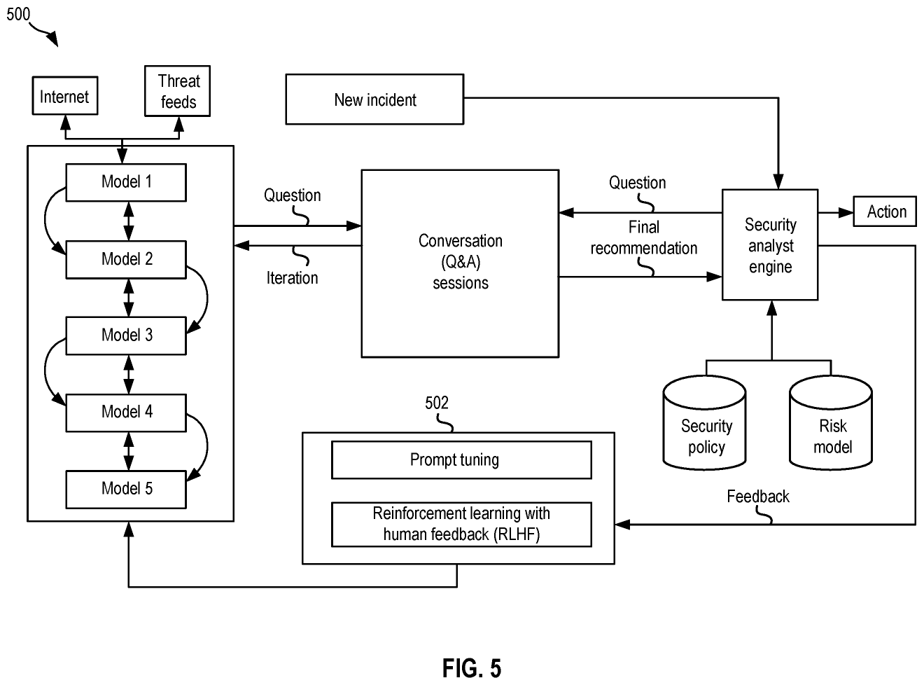

FIG. 5 depicts an environment architecture 500, in accordance with one embodiment. As an option, the present environment architecture 500 may be implemented in conjunction with features from any other embodiment listed herein, such as those described with reference to the other FIGS. Of course, however, such environment architecture 500 and others presented herein may be used in various applications and/or in permutations which may or may not be specifically described in the illustrative embodiments listed herein. Further, the environment architecture 500 presented herein may be used in any desired environment.

The environment architecture 500 includes a plurality of LLMs, e.g., see Model 1, Model 2, Model 3, Model 4, and Model 5, which may be fine-tuned using techniques described herein and training data, e.g., see Internet and Threat feeds. In some approaches, once the LLMs are sufficiently tuned, security analyst engines, e.g., see Security analyst engine which may be based on security policies and risk models, may use the tuned models to generate recommendations for an on-going incident, e.g., see New incident. This step may also be iterative, e.g., see Question and Iteration, where the models and the security analyst engine arrive at a final answer through a multi-step conversation or debate via a question thread, e.g., see Conversations (Q&A sessions). In some approaches, the security analyst engine may be delivered a plurality of refined resolutions to choose a final recommendation for mitigating the incident. In some other approaches, the LLMs determine a final resolution to take which may be an action to perform, e.g., see Action.

In some approaches, the LLMs utilize a combination of LangChain tools of a type that would become apparent to one of ordinary skill in the art after reading the descriptions herein. This enables an effective framework for reasoning and debating different potential resolutions related to the pros and cons of a cybersecurity incident response recommendation. By leveraging these tools, the LLMs may be caused, e.g., instructed, to consider a wide range of obtained information, including articles, blog posts, and research papers, which serve as valuable sources for supporting or countering arguments. Python REPL scripts provide a flexible environment to execute code snippets and perform various operations, allowing for dynamic reasoning and analysis of the different possible resolutions. Furthermore, the LLMs play a crucial role in understanding and generating the potential resolutions, aiding in the formulation of reasoned arguments and counterarguments. The combination of these tools empowers the engagement of insightful debates, presenting users with a balanced assessment of the advantages and disadvantages of different incident response recommendations in the realm of cybersecurity.

Furthermore, the LLMs may be updated periodically with new prompts and user feedback, e.g., see Feedback input into a model update engine 502. When new security vulnerabilities or malware appear, the security analyst engine may produce new tuning prompts for updating the models. In addition, all conversation histories and feedback may be recorded and combined to update the models using reinforcement learning (RL). For RL, security analysts may rank the responses of the models based on their relevance and the compliance level with a company's security policy and risk model. These rankings are then used to train the reward model for reinforcement learning, in some approaches.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method (CIM), the CIM comprising:
tuning a plurality of Large Language Models (LLMs) to debate one another to determine solutions for incidents;
causing data associated with a first incident to be input into the LLMs;
incorporating solutions output by the LLMs into a recommendation for resolving the first incident, wherein the recommendation weighs trade-offs of different possible resolutions for solving the first incident; and
outputting the recommendation to a user interface of a user device.

2. The CIM of claim 1, wherein the plurality of LLMs each have different model architectures selected from the group consisting of: encoder models, encoder-decoder models, and decoder-only models.

3. The CIM of claim 1, wherein training data is used to tune the LLMs to debate one another, wherein the training data is selected from the group consisting of: security data including past incident data, vulnerability, and mitigation data, and cyberthreat intelligence data.

4. The CIM of claim 3, wherein the tuning utilizes prompt-tuning techniques.

5. The CIM of claim 1, wherein the incident is a security incident, where at least some of the data associated with a first incident is received in a question from a user device.

6. The CIM of claim 1, comprising: receiving, from the user device, feedback about the recommendation for resolving the first incident; analyzing the feedback to determine whether the feedback is positive feedback or negative feedback; in response to a determination that the feedback is positive feedback, providing a reward to at least some of the LLMs; and in response to a determination that the feedback is negative feedback, providing the negative feedback to at least some of the LLMs.

7. The CIM of claim 6, comprising: assigning weights to the LLMs, wherein each of the weights establish an extent of influence that an associated LLM has while debating the other LLMs to determine solutions for incidents.

8. The CIM of claim 7, wherein providing the negative feedback to at least some of the LLMs includes: determining the LLMs that debated for including the solutions output by the LLMs, and decreasing the weights assigned to the determined LLMs a predetermined amount.

9. The CIM of claim 1, comprising: determining a preferred one of the resolutions, wherein the preferred resolution is highlighted within the recommendation.

10. A computer program product (CPP), the CPP comprising:
a set of one or more computer-readable storage media; and
program instructions, collectively stored in the set of one or more storage media, for causing a processor set to perform the following computer operations:
tune a plurality of Large Language Models (LLMs) to debate one another to determine solutions for incidents;
cause data associated with a first incident to be input into the LLMs;
incorporate solutions output by the LLMs into a recommendation for resolving the first incident, wherein the recommendation weighs trade-offs of different possible resolutions for solving the first incident; and
output the recommendation to a user interface of a user device.

11. The CPP of claim 10, wherein the plurality of LLMs each have different model architectures selected from the group consisting of: encoder models, encoder-decoder models, and decoder-only models.

12. The CPP of claim 10, wherein training data is used to tune the LLMs to debate one another, wherein the training data is selected from the group consisting of: security data including past incident data, vulnerability, and mitigation data, and cyberthreat intelligence data.

13. The CPP of claim 12, wherein the tuning utilizes prompt-tuning techniques.

14. The CPP of claim 10, wherein the incident is a security incident, where at least some of the data associated with a first incident is received in a question from a user device.

15. The CPP of claim 10, the CPP comprising: program instructions, collectively stored in the set of one or more storage media, for causing the processor set to perform the following computer operations: receive, from the user device, feedback about the recommendation for resolving the first incident; analyze the feedback to determine whether the feedback is positive feedback or negative feedback; in response to a determination that the feedback is positive feedback, provide a reward to at least some of the LLMs; and in response to a determination that the feedback is negative feedback, provide the negative feedback to at least some of the LLMs.

16. The CPP of claim 15, the CPP comprising: program instructions, collectively stored in the set of one or more storage media, for causing the processor set to perform the following computer operations: assign weights to the LLMs, wherein each of the weights establish an extent of influence that an associated LLM has while debating the other LLMs to determine solutions for incidents.

17. The CPP of claim 16, wherein providing the negative feedback to at least some of the LLMs includes: determining the LLMs that debated for including the solutions output by the LLMs, and decreasing the weights assigned to the determined LLMs a predetermined amount.

18. The CPP of claim 10, the CPP comprising: program instructions, collectively stored in the set of one or more storage media, for causing the processor set to perform the following computer operations: determine a preferred one of the resolutions, wherein the preferred resolution is highlighted within the recommendation.

19. A computer system (CS), the CS comprising:
a processor set;
a set of one or more computer-readable storage media;
program instructions, collectively stored in the set of one or more storage media, for causing the processor set to perform the following computer operations:
tune a plurality of Large Language Models (LLMs) to debate one another to determine solutions for incidents;
cause data associated with a first incident to be input into the LLMs;
incorporate solutions output by the LLMs into a recommendation for resolving the first incident, wherein the recommendation weighs trade-offs of different possible resolutions for solving the first incident; and
output the recommendation to a user interface of a user device.

20. The CS of claim 19, wherein the plurality of LLMs each have different model architectures selected from the group consisting of: encoder models, encoder-decoder models, and decoder-only models.
